(19) United States
(12) Patent Application Publication
(10) Pub. No.: US 2026/0019098 A1
(43) Pub. Date: Jan. 15, 2026

(54) UNIVERSAL MOUNT FOR DENSE INTEGRATION OF RADIO REMOTE UNITS

(71) Applicant: John Mezzalingua Associates, LLC, Liverpool, NY (US)

(72) Inventors: Thomas URTZ, North Syracuse, NY (US); Shawn CHAWGO, Phoenix, NY (US); Christopher NATOLI, Baldwinsville, NY (US)

(21) Appl. No.: 18/875,890

(22) PCT Filed: Jun. 26, 2023
(86) PCT No.: PCT/US2023/026197

§ 371 Date: Dec. 17, 2024

Related U.S. Application Data
(60) Provisional application No. 63/355,239, filed on Jun. 24, 2022.

(51) Int. Cl. H04B 1/08; H04B 1/10

(52) U.S. Cl. CPC H04B 1/08; H04B 1/1018

(57) ABSTRACT

A mounting apparatus for one or more radios has a mounting frame that can translate and pivot relative to its upper and lower wall brackets. The mounting frame has two sets of radio mounting brackets affixed to its first face and its second face, enabling two radios to be mounted, one of the first face and the other on the second face. This enables easy access to multiple radios for installation and maintenance and enables a denser packing of radios into limited spaced.

### BACKGROUND OF THE INVENTION

### Field of the Invention

The present invention relates to wireless communications, and more particularly, to high density mounting system for remote radio units.

### Related Art

Developments in cellular communications involve an increase in the number of frequency bands used for simultaneous transmission and reception between mobile devices and cellular base stations, and the proliferation of Multiple Input Multiple Output (MIMO) technology, which enables multiple simultaneous transmissions in a single frequency band. These developments have led to the deployment of an increasing number of radio remote units for a given base station. This is particularly true in the case of Distributed Antenna Systems (DAS) in which numerous radios may power antennas that are distributed throughout a building or dense urban environment.

In many cases, these increasingly sophisticated deployments may occur as enhancements to (or replacements of) existing cellular deployments, where there may not be sufficient space for mounting the additional remote radio units called for in a modern system.

Accordingly, what is needed is a mounting system for radio remote units that minimizes radio remote unit space requirements and enables dense placement of the radio remote units while enabling easy access to them for installation and servicing.

### SUMMARY OF THE DISCLOSURE

An aspect of the present disclosure involves an apparatus for mounting one or more radios. The apparatus comprises an upper wall bracket; a lower wall bracket; a mounting frame mechanically coupled to the upper wall bracket and the lower wall bracket by an upper pivot point and a lower pivot point, respectively; a first pair of radio mounting brackets coupled to a first face of the mounting frame, the first pair of radio mounting brackets configured to mount a first radio to the first face of the mounting frame; a second pair of radio mounting brackets coupled to a second face of the mounting frame, the second pair of radio mounting brackets configured to mount a second radio to the second face of the mounting frame; and wherein the upper pivot point is configured to translate within an upper wall bracket slot along a horizontal axis, and the lower pivot point is configured to translate within a lower wall bracket slot along the horizontal axis in conjunction with the upper pivot point, wherein the upper pivot point and the lower pivot point are configured to rotate the mounting frame around a vertical axis

### BRIEF DESCRIPTION OF THE DRAWINGS

FIG. 1 illustrated two radio remote units mounted using a mounting system according to the disclosure.

FIG. 2 illustrates one of the two radio remote units of FIG. 1 being either inserted into or removed from the mounting system.

FIG. 3 illustrates an exemplary pivot feature of the mounting system of the disclosure.

FIG. 4 illustrates an exemplary latch feature of the mounting system of the disclosure.

FIG. 5 illustrates an exemplary fastener of the mounting system of the disclosure.

FIG. 6 illustrates an exemplary locking bolt of the mounting system of the disclosure.

FIG. 7 illustrates a plurality of radio remote unit pairs mounted in angled, flat, and orthogonal orientations according to the disclosure.

FIG. 8 illustrates an exemplary deployment of a plurality of radio remote unit pairs mounted in an orthogonal orientation and on tilted mounting racks according to the disclosure.

FIG. 9 illustrates an exemplary mount according to the disclosure, projected at an angle.

FIG. 10 illustrates the exemplary mount of FIG. 9 but at from an orientation orthogonal to the plane of the radio mount.

FIG. 11 illustrates the exemplary mount of FIG. 9 but from above the mount, viewed along the plane of the radio mount.

### DESCRIPTION OF EXEMPLARY EMBODIMENTS

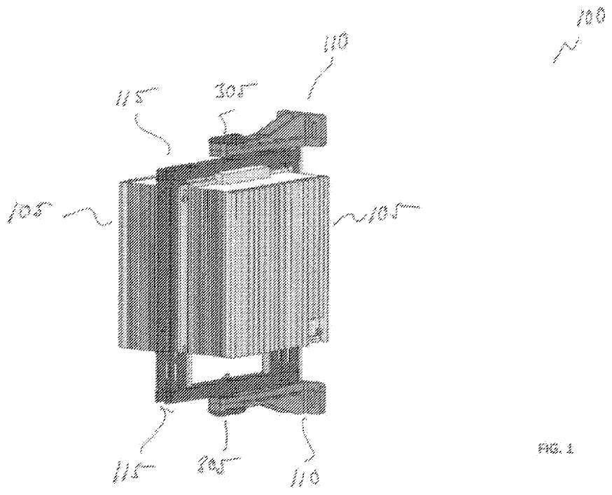

FIG. 1 illustrates an exemplary dual-radio mount 100 in an orthogonal configuration. Dual-radio mount 100 includes an upper and lower wall bracket 110, both of which are coupled to a mounting frame 115. Mechanically coupled to mounting frame 115 are two radios 105.

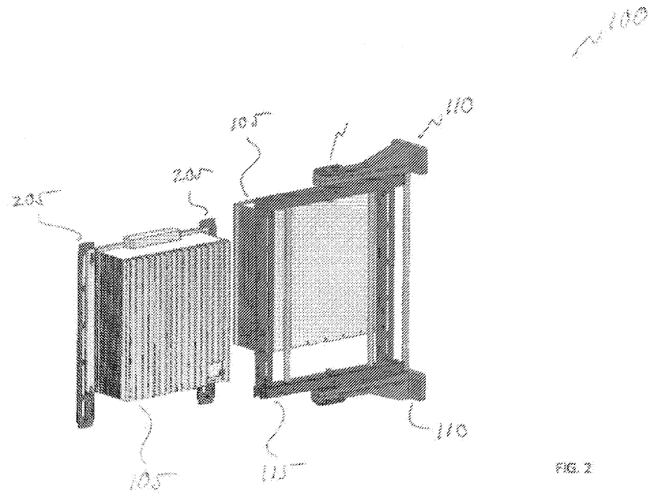

FIG. 2 illustrates the exemplary dual radio mount 100 with one of the radios 105 removed. As illustrated, each radio 105 is mounted to two vertical radio brackets 205. For each radio 105, the vertical radio brackets 205 enable the corresponding radio 105 and the two radio brackets 205 to be installed as an assembly by sliding the radio brackets 205 into mounting frame 115. Mounting frame 115 has a pair of slots, each of which is configured to accommodate the radio brackets 205 of a given radio 105. This enables easy installation and removal of radio 105 to/from dual-radio mount 100.

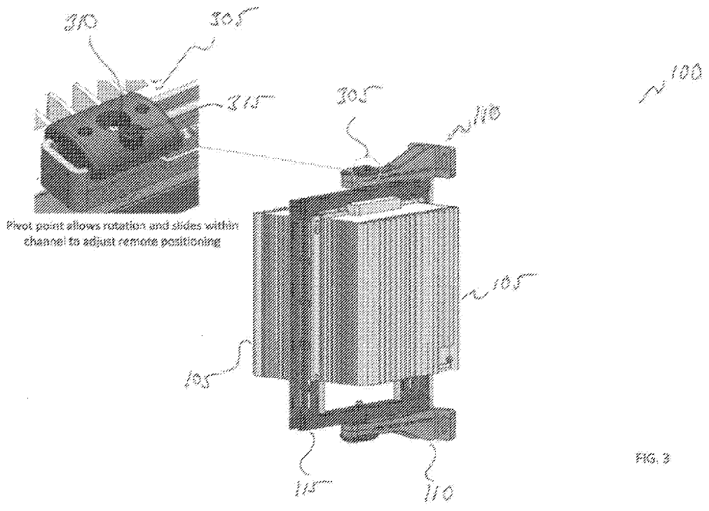

FIG. 3 illustrates exemplary dual-radio mount 100, highlighting a pivot point 305, which enables mounting frame 115 with both radios 105 to be rotated, as is described further below. Pivot point 305 may be mechanically coupled to mounting frame 115 and may include a pivot axis 310 and a pivot lock 315, which fixes the angular orientation of mounting frame 115. Pivot point 305 may be configured to slide along mounting frame 115 to accommodate different angular orientations described below.

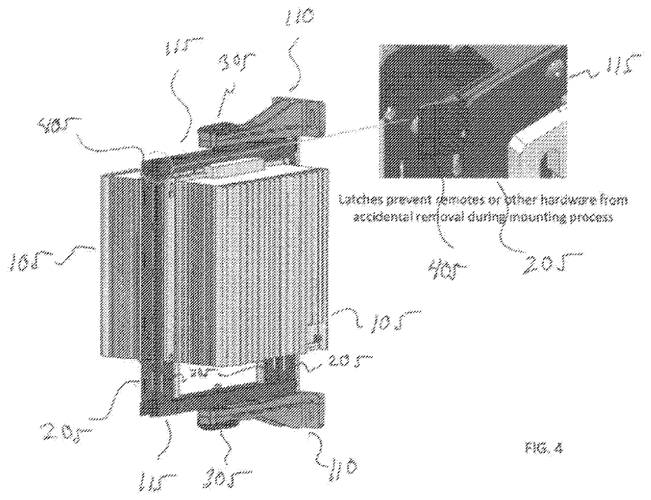

FIG. 4 illustrates exemplary dual-radio mount 100, highlighting a latch 405, one per radio 105, which prevents the assembly of radio 105 and radio brackets 205 from accidental removal during the mounting process.

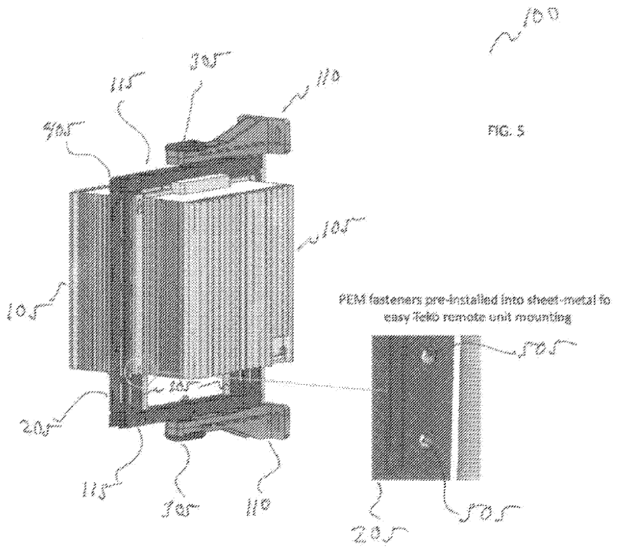

FIG. 5 illustrates exemplary dual-radio mount 100, highlighting threaded inserts disposed within radio brackets 205 for bolting radio 105 to radio bracket 205.

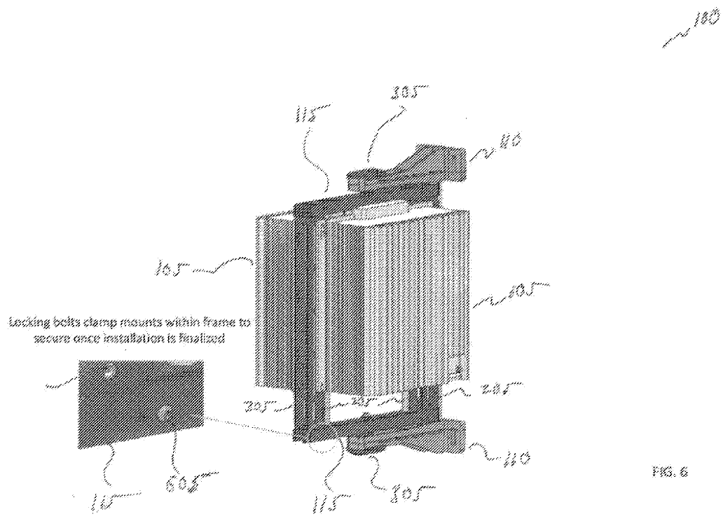

FIG. 6 illustrates exemplary dual-radio mount 100, highlighting locking bolts 605 that affix radio brackets 205 to mounting frame 115 according to the disclosure. Locking bolts 605 would be affixed as a final step in the installation of the assembly of radio 105 and radio brackets 205 into mounting frame 115.

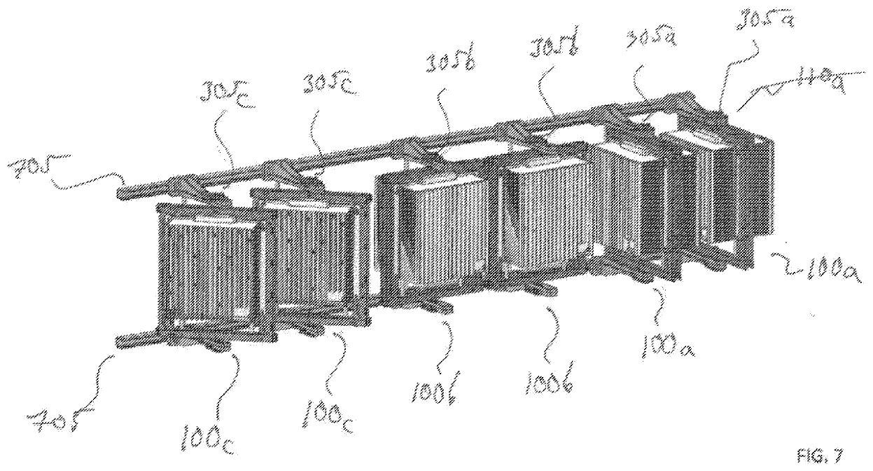

FIG. 7 illustrates an exemplary radio deployment 700 having a plurality of dual-radio mounts 100 installed on a pair of mounting rails 705. In this example, six dual-radio mounts 100 are shown: two mounted in an orthogonal configuration (100a); two mounted in a flat configuration (100b); and two mounted in an angled configuration (100c). The orthogonal configuration 100a might be preferred in an installation that has tighter width constraints than depth constraints. In this case, aligning the radios 105 accordingly enables a dense packing in terms of width. The flat configuration 100b might be preferred in an installation with tighter depts constraints than width constraints. The angled configuration 100c might be preferred where space constraints lie somewhere between those for configurations 100a and 100b.

Reconfiguring a dual-radio mount 100 from between orthogonal configuration 100a and flat configuration 100b involved both translating pivot point 305 along a slot disposed within upper and lower wall brackets 110 and rotating mounting frame 115 to the desired angular orientation.

Further, regardless of orientation 100a/b/c, dual-radio mount 100 enables the radios 105 to be rotated so that they may be easily accessed for installation and maintenance.

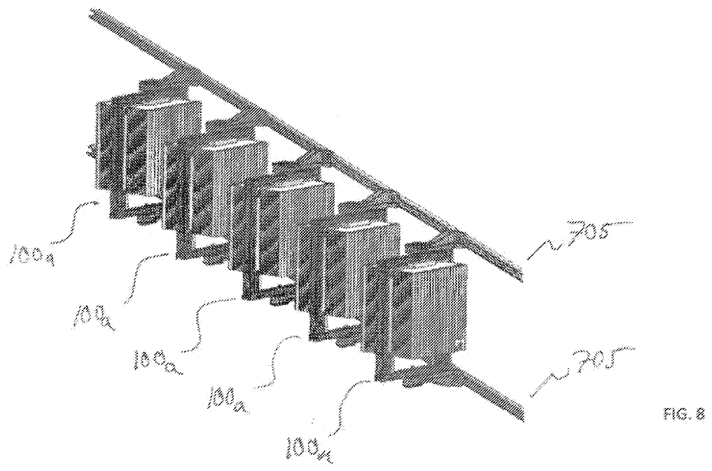

FIG. 8 illustrates an exemplary radio deployment 800 in a tilted configuration. This may be useful in a building such as a stadium, etc. As illustrated, five dual-radio mounts 100 in orthogonal configuration 100a are mounted to tilted mounting rails 700. Tilted mounting is enabled by having slotted mounting holes in upper and lower wall brackets 110.

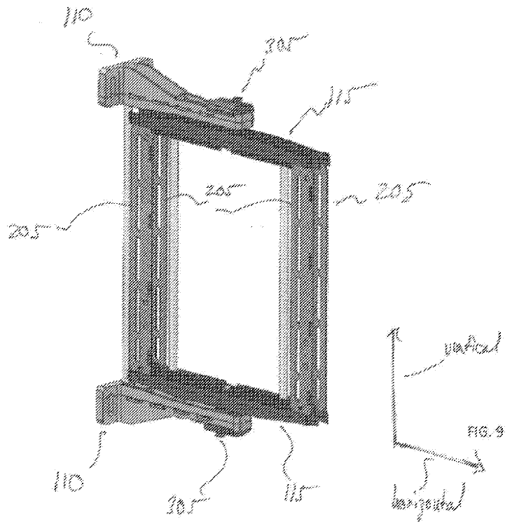

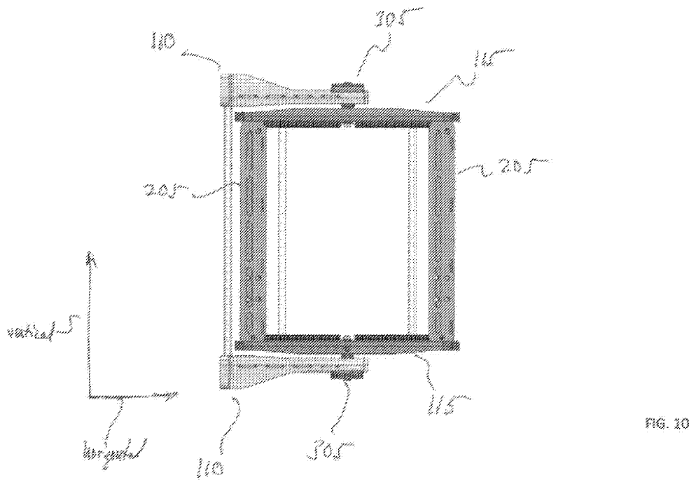

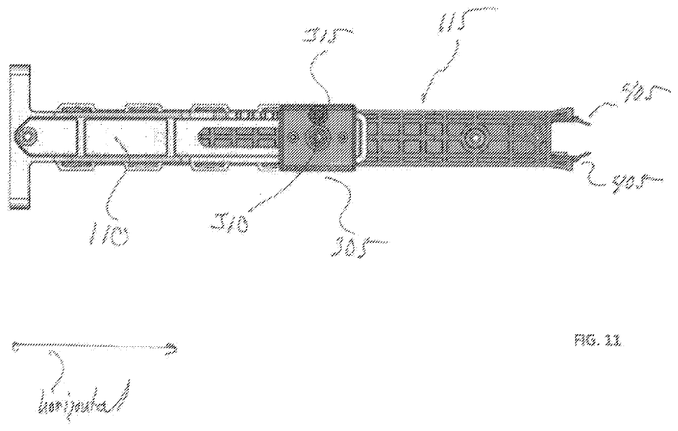

FIGS. 9-11 provide three different angular views of dual-radio mount 100 with radios 105 removed. Accordingly, illustrated are upper and lower wall brackets 110, pivot point 305 disposed on the upper and lower wall brackets, which respectively mechanically couple with mounting frame 105, to which vertical radio brackets 205 having latches 405 are installed.

Also shown in FIGS. 9-11 are a pair of axes: a vertical axis, and a horizontal axis.

Variations are possible and within the scope of the disclosure. For example, the two radios 105 installed on dual-radio mount 100 may be different in that they cover different frequency bands (e.g., low band and mid band, etc.). In this case, the radios 105 may be of different size and geometries. This may enable additional components (e.g., splitter/combiners, filter, etc.) to be mounted alongside the smaller radio 105, further reducing the space needed for components to support radios 105. A third radio bracket (not shown) may be required for mounting the additional component alongside the adjacent smaller radio. This may significantly reduce the lengths of cables (now shown) between each radio 105 and the additional component, which may not only reduce cost and overall volume of cabling required, but it may also reduce signal losses endemic of cabling within the given installation. It will be understood that such variations are possible and within the scope of the disclosure.

Although the disclosure refers to radios 105 being mounted to dual-radio mount 100, it will be understood that the term radio may refer to telecommunications equipment that are associated with radios: e.g., filters, splitters, digital electricity receivers, over voltage protection devices, etc., and that such variations are within the scope of the disclosure.

What is claimed is:

1. An apparatus for mounting one or more radios, comprising:
an upper wall bracket;
a lower wall bracket;
a mounting frame mechanically coupled to the upper wall bracket and the lower wall bracket by an upper pivot point and a lower pivot point, respectively;
a first pair of radio mounting brackets coupled to a first face of the mounting frame, the first pair of radio mounting brackets configured to mount a first radio to the first face of the mounting frame; and
a second pair of radio mounting brackets coupled to a second face of the mounting frame, the second pair of radio mounting brackets configured to mount a second radio to the second face of the mounting frame,
wherein the upper pivot point is configured to translate within an upper wall bracket slot along a horizontal axis, and the lower pivot point is configured to translate within a lower wall bracket slot along the horizontal axis in conjunction with the upper pivot point and wherein the upper pivot point and the lower pivot point are configured to rotate the mounting frame around a vertical axis.

2. The apparatus of claim 1, wherein the upper pivot point comprises:
an upper pivot axis; and
an upper pivot lock.

3. The apparatus of claim 1, wherein the lower pivot point comprises:
a lower pivot axis; and
a lower pivot lock.

4. The apparatus of claim 1, wherein the first pair of radio mounting brackets further comprises a third mounting bracket.

5. The apparatus of claim 4, wherein the first pair of radio mounting brackets and the third mounting bracket are configured for mounting the first radio and an additional radio component.

6. The apparatus of claim 5, wherein the additional radio component comprises a combiner/splitter.

7. The apparatus of claim 5, wherein the additional radio component comprises a filter.

8. The apparatus of claim 1, wherein the mounting frame comprises:
a first latch corresponding to the first face; and
a second latch corresponding to the second face.

9. The apparatus of claim 1, further comprising:
a first radio mounted to the first pair of radio mounting brackets; and
a second radio mounted to the second pair of radio mounting brackets.
